(19) United States
(12) Patent Application Publication
(10) Pub. No.: US 2022/0116232 A1
(43) Pub. Date: Apr. 14, 2022

(54) DISTRIBUTED OR CLOUD COMPUTING SYSTEM INFORMATION

(71) Applicant: Nokia Solutions and Networks Oy, Espoo (FI)

(72) Inventors: Ian OLIVER, Soderkulla (FI); Borger VIGMOSTAD, Helsinki (FI); Gabriela LIMONTA, Espoo (FI)

(73) Assignee: Nokia Solutions and Networks Oy, Espoo (FI)

(21) Appl. No.: 17/426,185

(22) PCT Filed: Jan. 30, 2019
(86) PCT No.: PCT/FI2019/050066

§ 371 Date: Jul. 28, 2021

(51) Int. Cl. H04L 9/32; H04L 9/08

(52) U.S. Cl. CPC H04L 9/3271; H04L 9/0897; H04L 9/3247; H04L 9/3236; H04L 9/321

(57) ABSTRACT

An apparatus, method and computer program perform our cause to perform receiving a request at an element of distributed or cloud computing system, wherein the request includes a command; a nonce; and details of a cryptographic key for use in responding to the request; generating a response to the request at a trust agent of the element of said computing system; and providing the response to in response to the request, wherein the response includes the nonce and is signed using the cryptographic key.

### FIELD

The present specification relates to obtaining or providing information relating to a distributed or cloud computing system.

### BACKGROUND

Distributed or cloud computing systems may include a wide range of hardware and software modules. For example, a telecommunications cloud system may include modules such as devices than run virtual workload, base stations and edge devices. It may, in some circumstances, be desirable to obtain information about such devices, such as software and firmware running on said devices. There remains a need for alternative or improved systems in this field.

### SUMMARY

In a first aspect, this specification describes an apparatus comprising: means for receiving a request, from a first module (e.g. an attestation server), at an element of a distributed or cloud computing system, wherein said request includes: a command (e.g. commands requesting identity, quote or capabilities information); a nonce; and details of a cryptographic key for use in responding to the request; means for generating a response to said request at said element (e.g. at a trust agent of said element) of said computing system, wherein said response includes one or more of the following, depending on said command: an identity of said element; a cryptographic hash of data representing configurations of said element; and capabilities relating to said element of the computing system; and means for providing said response to said first module in response to said request, wherein said response includes said nonce and is signed using said cryptographic key. The first module may refer to a device calling the trust agent, which device may be an attestation server. The response to said request may be generated at a trust agent of said element.

The request may comprise additional data including a cryptographic key (or a reference thereto). The request may include encryption structures providing by the relevant transport layer (e.g. SSL/TLS).

Some embodiments comprise a trust agent at said element of said computing system for providing an interface between said element of the computing system and said first module. The trust agent may receive the request from the first module (e.g. an attestation server) and return the response to the first module. The trust agent may, at least in part, generate the response to the request. Thus, the trust agent may be: the means for receiving the request; the means for generating the response; and/or the means for providing the response, as discussed above.

Some embodiments comprise a trusted platform module (TPM) associated with said element of said computing system. The trusted platform module may form part of said element of said computing system. The trusted platform module may be a physical device, but alternatively may be a specification of behaviour that the element of the computing system provides.

The identity of said element may include public keys of said trusted platform module (such as public keys of an endorsement key pair and/or an attestation key pair). Other information (instead of, or in addition to, said public keys) may be provided in a non-TPM embodiment. For example, some embodiments may have a single key (e.g. some hardware security modules have a single key, sometimes known as an attestation key).

The cryptographic hash of data representing configurations of said element may be generated by said trusted platform module.

The cryptographic hash of data representing configurations of said element may a cryptographic hash of data representing one or more of hardware, firmware and software configurations of said element. Said configurations may be stored in one or more platform configuration registers (PCRs).

The capabilities may identify measurements that can be provided to said first module (e.g. to the attestation server) or to some other device requesting information from the trust agent. An attestation server is one example, other examples include a management and operation component of a cloud server. Moreover, a proxy could be allowed to forward requests to the trust server on behalf of an attestation server. Another use case might be that a user interface component or a system status component calls the trust agent(s) directly.

Some embodiments may further comprise: means for generating a first response that includes said nonce and is signed using said cryptographic key (i.e. the nonce and the key included in said request); and means for generating a second response that includes said first response and metadata and is signed using a second cryptographic key, wherein the response provided to said first module in response to said request is based on said second response.

Some embodiments comprise means for establishing an enclave, wherein said response is generated within said enclave.

Some embodiments comprise a hardware security module for use in cryptographically signing parts of said response to said request.

The said element may be one of a plurality of elements of the computing system (e.g. multiple elements of a cloud or distributed computing system).

The said means may comprise: at least one processor; and at least one memory including computer program code, the at least one memory and the computer program configured, with the at least one processor, to cause the performance of the apparatus.

In a second aspect, this specification describes a system comprising a plurality of apparatuses as described above with reference to the first aspect and further comprising said first module (e.g. an attestation server).

In a third aspect, this specification describes a method comprising: receiving a request, from a first module (e.g. an attestation server), at an element of a distributed or cloud computing system, wherein said request includes: a command; a nonce; and details of a cryptographic key for use in responding to the request; generating a response to said request at a trust agent of said element of said computing system, wherein said response includes one or more of the following, depending on said command: an identity of said element; a cryptographic hash of data representing configurations of said element; and capabilities relating to said element of the computing system; and providing said response to said first module in response to said request, wherein said response includes said nonce and is signed using said cryptographic key.

The first module may refer to a device calling the trust agent, which device may be an attestation server. The response to said request may be generated at a trust agent of said element.

Some embodiments comprise a trust agent at said element of said computing system for providing an interface between said element of the computing system and said first module. The trust agent may receive the request from the first module (e.g. an attestation server) and return the response to the first module. The trust agent may, at least in part, generate the response to the request.

Some embodiments comprise a trusted platform module associated with said element of said computing system. The trusted platform module may form part of said element of said computing system.

The identity of said element may include public keys of said trusted platform module (such as public keys of an endorsement key pair and/or an attestation key pair).

The cryptographic hash of data representing configurations of said element may be generated by said trusted platform module.

The cryptographic hash of data representing configurations of said element may be a cryptographic hash of data representing one or more of hardware, firmware and software configurations of said element. Said configurations may be stored in one or more platform configuration registers (PCRs).

The capabilities may identify measurements that can be provided to said first module (e.g. to the attestation server) or to some other device requesting information from the trust agent.

Some embodiments may further comprise: generating a first response that includes said nonce and is signed using said cryptographic key; and generating a second response that includes said first response and metadata and is signed using a second cryptographic key, wherein said response provided to said first module in response to said request is based on said second response.

Some embodiments comprise establishing an enclave, wherein said response is generated within said enclave.

Some embodiments comprise a hardware security module for use in cryptographically signing parts of said response to said request.

In a fourth aspect, this specification describes any apparatus configured to perform any method as described with reference to the third aspect.

In a fifth aspect, this specification describes computer-readable instructions which, when executed by computing apparatus, cause the computing apparatus to perform any method as described with reference to the third aspect.

In a sixth aspect, this specification describes a computer program comprising instructions for causing an apparatus to perform at least the following: receive a request, from a first module, at an element of a distributed or cloud computing system, wherein said request includes: a command; a nonce; and details of a cryptographic key for use in responding to the request; generate a response to said request at a trust agent of said element of said computing system, wherein said response includes one or more of the following, depending on said command: an identity of said element; a cryptographic hash of data representing configurations of said element; and capabilities relating to said element of the computing system; and provide said response to said first module in response to said request, wherein said response includes said nonce and is signed using said cryptographic key.

In a seventh aspect, this specification describes a computer-readable medium (such as a non-transitory computer readable medium) comprising program instructions stored thereon for performing at least the following: receiving a request, from a first module, at an element of a distributed or cloud computing system, wherein said request includes: a command; a nonce; and details of a cryptographic key for use in responding to the request; generating a response to said request at a trust agent of said element of said computing system, wherein said response includes one or more of the following, depending on said command: an identity of said element; a cryptographic hash of data representing configurations of said element; and capabilities relating to said element of the computing system; and providing said response to said first module in response to said request, wherein said response includes said nonce and is signed using said cryptographic key.

In an eighth aspect, this specification describes an apparatus comprising: at least one processor; and at least one memory including computer program code which, when executed by the at least one processor, causes the apparatus to: receive a request, from a first module, at an element of a distributed or cloud computing system, wherein said request includes: a command; a nonce; and details of a cryptographic key for use in responding to the request; generate a response to said request at a trust agent of said element of said computing system, wherein said response includes one or more of the following, depending on said command: an identity of said element; a cryptographic hash of data representing configurations of said element; and capabilities relating to said element of the computing system; and provide said response to said first module in response to said request, wherein said response includes said nonce and is signed using said cryptographic key.

In a ninth aspect, this specification describes an apparatus comprising: a first input for receiving a request from a first module (e.g. an attestation server), at a trust agent (or some other element of a distributed or cloud computing system), wherein said request includes: a command (e.g. commands requesting identity, quote or capabilities information); a nonce; and details of a cryptographic key for use in responding to the request; a trust agent (or some other element) for generating a response to said request, wherein said response includes one or more of the following, depending on said command: an identity of said element; a cryptographic hash of data representing configurations of said element; and capabilities relating to said element of the computing system; and an output (e.g. an output of said trust agent) for providing said response to said first module in response to said request, wherein said response includes said nonce and is signed using said cryptographic key.

### BRIEF DESCRIPTION OF THE DRAWINGS

Example embodiments will now be described, by way of non-limiting examples, with reference to the following schematic drawings, in which:

FIG. 1 is a block diagram of a system in accordance with an example embodiment;

FIG. 2 is a block diagram of a system in accordance with an example embodiment;

FIG. 3 is a flow chart showing an algorithm in accordance with an example embodiment;

FIG. 4 is a message sequence in accordance with an example embodiment;

FIG. 5 is a flow chart showing an algorithm in accordance with an example embodiment;

FIGS. 6 to 9 show message sequences in accordance with example embodiments;

FIG. 10 is a block diagram of components of a system in accordance with an example embodiment; and

FIGS. 11A and 11B show tangible media, respectively a removable memory unit and a compact disc (CD) storing computer-readable code which when run by a computer perform operations according to example embodiments.

### DETAILED DESCRIPTION

Computing systems, including (but not limited to) distributed or cloud computing systems, may include a wide range of hardware elements connected thereto. Such modules may, for example, be provided to run virtual workloads, base stations of a telecommunication network, edge devices etc. It may be desirable to know a state or status of such devices, including details of software and/or firmware that such devices are running. Moreover, a system may want to determine that it is communicating with the correct device.

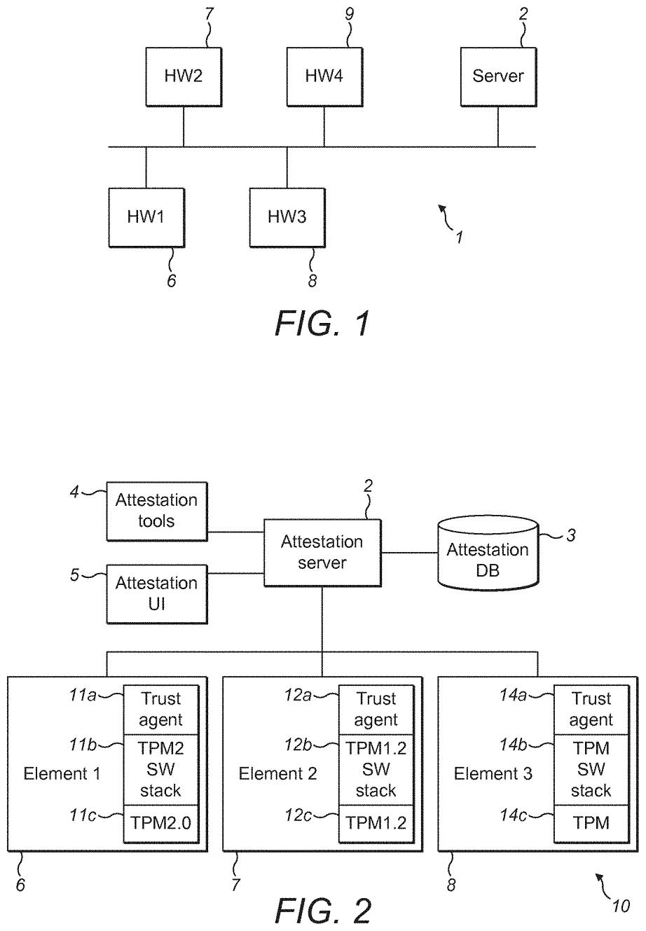

FIG. 1 is a block diagram of a system, indicated generally by the reference numeral 1, in accordance with an example embodiment. The system 1 comprises an attestation server 2, a first element 6, a second element 7, a third element 8 and a fourth element 9. The first to fourth elements 6 to 9 may be hardware modules and, as shown in FIG. 1, are in communication with the server 2 via a network bus. The elements 6 to 9 may form part of a distributed or cloud computing system. The attestation server 2 may, for example, be tasked with monitoring a trust status of the system 1 and the elements within the system.

In order to monitor aspects of the system 1, the server 2 may communicate with each of the elements 6 to 9 to obtain measurements. For example, a trusted platform module (TPM) may be provided at each element to generate a cryptographic hash that summarises the hardware and software configuration of the relevant module. A set of platform configuration registers (PCRs) may be provided which store cryptographic hashes of measurements of the relevant components. A hash may, for example, be obtained from a TPM by a mechanism known as quoting. A quote may be generated for a set of PCRs, with the TPM generating a hash from the contents of the set of PCRs and signing them with an attestation key (AK) unique to the respective TPM (e.g. with a private key of an attestation key pair).

FIG. 2 is a block diagram of a system, indicated generally by the reference numeral 10, in accordance with an example embodiment.

The system 10 comprises the attestation server 2 and the first, second and third elements 6 to 8 of the system 1 described above. The system 10 additionally comprises an attestation database 3, attestation tools 4, and an attestation user interface 5 in communication with the attestation server 2. The first, second and third elements 6 to 8 are provided by way of example. Clearly more (or fewer) elements may be provided within a system (such as the element 9 described above). The elements 6 to 8 may be elements of a cloud computing system (e.g. a trusted cloud).

The attestation server 2 may offer a query application programming interface (API) that can be used, for example, by command line tools. The user interface 5 of the system 10 (e.g. a web application) may enable a user to interact with the attestation server 2 (e.g. to enable viewing of a trust status of a cloud or to request measurements of one or more elements of the system 10).

The first element 6 comprises a trust agent 11a, a trusted platform module (TPM) software stack 11b and a trusted platform module 11c. Similarly, the second element 7 comprises a trust agent 12a, a trusted platform module (TPM) software stack 12b and a trusted platform module 12c. The third element 8 comprises a trust agent 14a, a trusted platform module (TPM) software stack 14b and a trusted platform module 14c.

The trust agents 11a, 12a and 14a at each element of the system 10 provide an interface between the respective element and the attestation server 2.

As indicated above, each of the elements 6 to 8 of the system may have a trusted platform module associated therewith. The trusted platform module may form part of the respective element (as shown in FIG. 2). The trusted platform module may be implemented as a device of the respective element, but may alternatively be distributed. In essence, the trusted platform module is a specification of behaviour implemented by the relevant element.

The trusted platform modules (TPMs) 11c, 12c and 14c may store cryptographic keys, certification and confidential data. For example, two unique key-pairs may be stored at (or be available to) each TPM: an endorsement key pair (EK) and an attestation key pair (AK).

A set of platform configuration registers (PCRs) may be provided to store measurements, in the form of hashes, of hardware or software components of the relevant machine (e.g. the element within which the TPM is installed). A TPM may be asked for provide a “quote” for a defined set of PCRs (e.g. a hash over the stored value of the defined PCRs). The TPM may then return the quote for the requested PCRs, a cryptographic signature of that quote (signed by the attestation key, e.g. the private key of the attestation key pair) and possibly other information, such as a timestamp and a reboot count.

An attestation policy is a set of expected values for different measurements that can be taken from a machine (such as one or more of the elements 6 to 9 described above). If a machine has a TPM, a policy can be a mapped between a PCR number and an expected value. An administrator can define policies in order for a machine to be considered in a trusted state. When attestation is carried out, the measurements can be checked against the expected values in the policy. The expected values are reference values that can be used to define a “correct” state of a system and/or can be used to detect changes in a system. When quoting, if a machine stops following a certain policy, this may indicate that what was measured by the policy has changed in the system.

The attestation server 2 may be responsible for obtaining quotes from the elements 6 to 8 (and optionally the element 9). For example, the attestation server may be responsible for attesting the devices and checking the status of the relevant system (e.g. the system 1 or the system 10). During an attestation process, the attestation server 2 may compare values obtained by quoting an element to a defined attestation policy for the relevant element(s).

Then, if measurements from an element no longer satisfy the relevant policy/policies, an action may be initiated (e.g. generating system alerts for administrators).

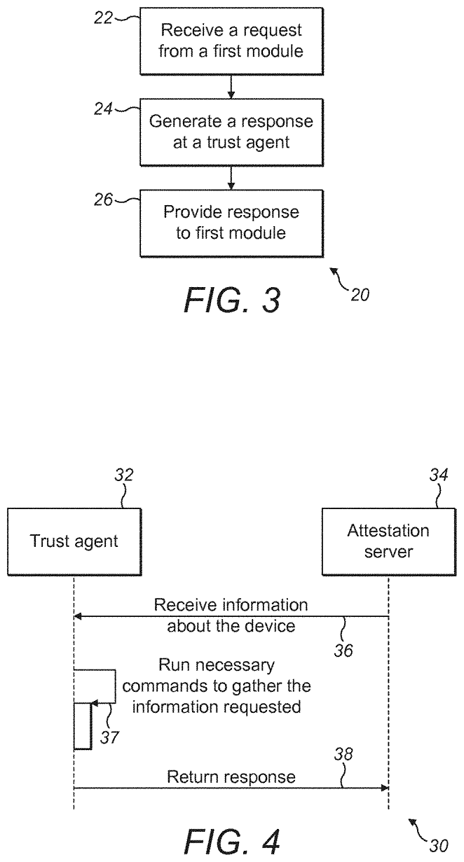

FIG. 3 is a flow chart showing an algorithm, indicated generally by the reference numeral 20, in accordance with an example embodiment. The algorithm 20 may be implemented as any one of the elements 6 to 8 of the system 10.

The algorithm 20 starts at operation 22, where a request is received from a first module (such as the attestation server 2) at a request receiving means of one of the elements of the system (such as one of the elements 6 to 8 of the system 10 described above). As described further below, the request may include a command, a nonce (to prevent replay attacks) and details of a cryptographic key for use in responding to the request. In addition, cryptographic structures may be provided by the relevant transport layer (e.g. secure sockets layer (SSL) or transport layer security (TLS)).

At operation 24, a response to said request is generated at a response generating means of the respective element of the system 10. The response may be generated at a trust agent of the respective element (such as one of the trust agents 11a, 12a and 14a described above).

The response may include one or more of the following (depending on the received command): an identity of said element; a cryptographic hash of data representing configurations of said element; and capabilities relating to said element of the computing system.

At operation 26, the response is provided to the first module (such as the attestation server 2) in response to said request. As described further below, the response includes the nonce (as provided in the request) and is signed using the cryptographic key (as identified in the request).

Thus, in the system 10, the relevant trust agent (11a, 12a, 14a) may receive the request from the attestation server 2 and return the response to the attestation server. The relevant trust agent may, at least in part, generate the response to the request. Thus, the trust agent may be one or more of: the means for receiving the request (operation 22 discussed above); the means for generating the response (operation 24 discussed above); and the means for providing the response (operation 26 discussed above).

FIG. 4 shows a message sequence, indicated generally by the reference numeral 30, in accordance with an example embodiment. The message sequence 30 is an example implementation of the algorithm 20 described above.

The message sequence 30 is implemented between a trust agent 32 (such as one of the trust agents 11a, 12a and 14a described above) and an attestation server 34 (such as the server 2 described above).

A request 36 is received at the trust agent 32 from the attestation server 34, implementing the operation 22. The request consists of a command (such as the get_identity, get_quote and get_capabilities commands discussed further below) and possible additional data, such as a nonce and a cryptographic key. Of course, other commands could also be implemented in example embodiments.

The trust agent 32 processes the request 36 and runs any commands on the system needed for gathering the requested information (as indicated by the reference numeral 37).

Finally, the trust agent sends a response 38 to the attestation server with the requested information, implementing the operation 26. Details of example responses 38 are provided below.

As indicated above, the request 32 may include one or more of: get_identity; get_quote; and get_capabilities commands.

A get_identity command may request the identity of the element that the trust agent 32 is running on (e.g. the identity of the relevant element 6 to 9). In the case of a device with a trusted platform module (TPM), the identity may take the form of public keys of the trusted platform module (e.g. public keys of endorsement key (EK) and attestation key (AK) pairs). Alternatively, or additionally, the identity may include metadata that can be used to identify the relevant machine, but may not be permanent identities (e.g. an IP address, MAC address, system information OpenStack ID etc.). Other implementations (e.g. non-TPM based implementations) are possible. For example, a single key may be provided. In some hardware security modules, for example, a single key, sometimes called an attestation key, may be provided.

A get_quote command may request the results of quoting or measuring an element on which the trust agent 32 is running, according to some policy indicated by the attestation server 34. The quote may take the form of a cryptographic hash of data representing configurations of said element and may be generated by a trusted platform module. In one embodiment, a cryptographic hash of data representing configurations of an element is a cryptographic hash of data representing hardware, firmware and/or software configurations of said element (as stored, for example, in one or more platform confirmation registers).

A get_capabilities command may request information about the capabilities of the device, such as the trusted platform module, TPM. A response to a get_capabilities command may identify measurements (or other data) that can be provided to the attestation server. Thus, the capabilities may be used to decide what kind of measurements can be obtained by the attestation server 34 from the respective element. The capabilities information may also be used to identify properties of the TPM, such as the manufacturer or the installed firmware version.

The response 38 may include one or more of the following fields:
Type. The type field may identify a type of the relevant device. The type field may, for example, be used by the attestation server 34 to determine what fields and/or data to expect in the response;
Nonce (e.g. the nonce included in the request). Thus, the response can be matched with the appropriate request;
Command (e.g. the name of the command, as provided in the request, such as ‘get_identity’, ‘get_quote’, or ‘get_capabilities’);
timestamp_start (e.g. indicating when the request was received);
timestamp_end (e.g. indicating when the trust agent completed processing the request); and
signature (e.g. the signature of the response object, using the key indicated in the parameters of the request).

Of course, other fields may be provided instead of, or in addition to, some or all of the fields described above.

By way of example, in the case of a device with a TPM 2.0, a response to a get_identity request may take the following form:

{
‘type’: ‘TPM2’,
‘nonce’: 1234,
‘command’: ‘get_identity’,
‘timestamp_start’: ‘2018-06-07 10:08:20.789000+03:00’,
‘timestamp_end’: ‘2018-06-07 10:08:22.856000+03:00’,
‘identity’: {
‘ek’: ‘-----BEGIN PUBLIC KEY----- (...) -----END PUBLIC KEY-----’,
‘ak’: ‘-----BEGIN PUBLIC KEY----- (...) -----END PUBLIC KEY-----’,
},
‘extra_data’: {
‘uname’: ‘Linux localhost.localdomain 4.16.7-200.local.fc27.x86_64 #1 SMP Fri May 4
00:20:26 EEST 2018 x86_64 x86_64 x86_64 GNU/Linux’,
...
},
‘signature’: ‘...’
}

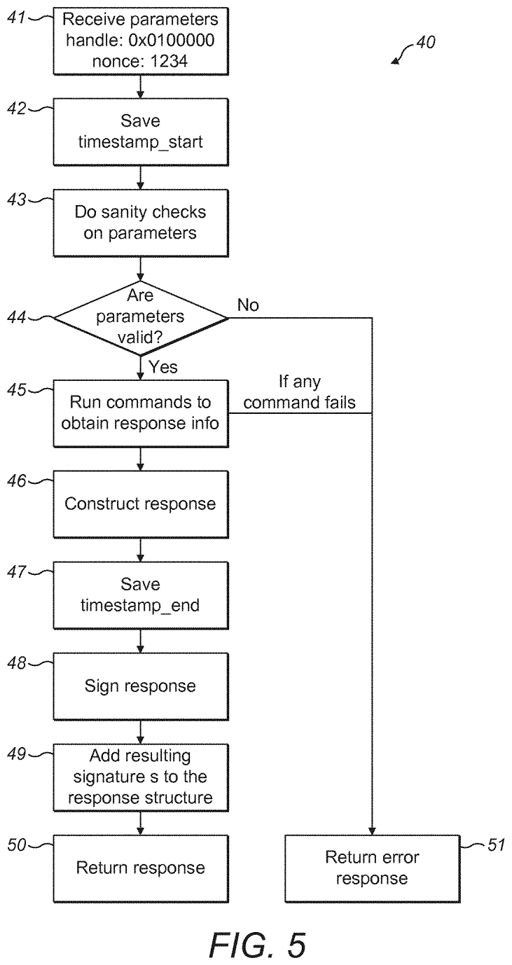

FIG. 5 is a flow chart showing an algorithm, indicated generally by the reference numeral 40, in accordance with an example embodiment. The algorithm 40 is an example implementation of the algorithm 20 (and the message sequence 30). The algorithm 40 may be implemented at a trust agent, such as the trust agents 11a, 12a, 14a and 32 described above.

The algorithm 40 starts at operation 41 where a request is received, including a set of parameters (e.g. a key handle and a nonce). Thus, the operation 41 is an example of the request 36 described above.

At operation 42, the time stores a timestamp (timestamp_start) when the request is received in the operation 41.

At operation 43, the trust agent performs sanity checks on the parameters to determine whether those parameters seem to be valid. If, at operation 44, the parameters are deemed to be valid, then the algorithm moves to operation 45; otherwise the algorithm moves to operation 51, where an error response is returned and the algorithm terminates.

At operation 45, the trust agent runs the commands needed to obtained the requested information (see the operation 37 of the message sequence 30 described above). If all commands are successful, then the algorithm moves to operation 46. However, if any command fails, the algorithm moves to operation 51, where an error response is returned and the algorithm terminates.

At operation 46, a response to the request is constructed and, at operation 47, the trust agent stores a timestamp indicating the time at which processing of the request was completed.

At operation 48, the trust agent signs the response object and adds the resulting signature to the response structure at operation 49.

At operation 50, the trust agent returns the response, with the requested information, to the attestation server that provided the original request. Thus, the operation 50 is an example of the response 38 described above.

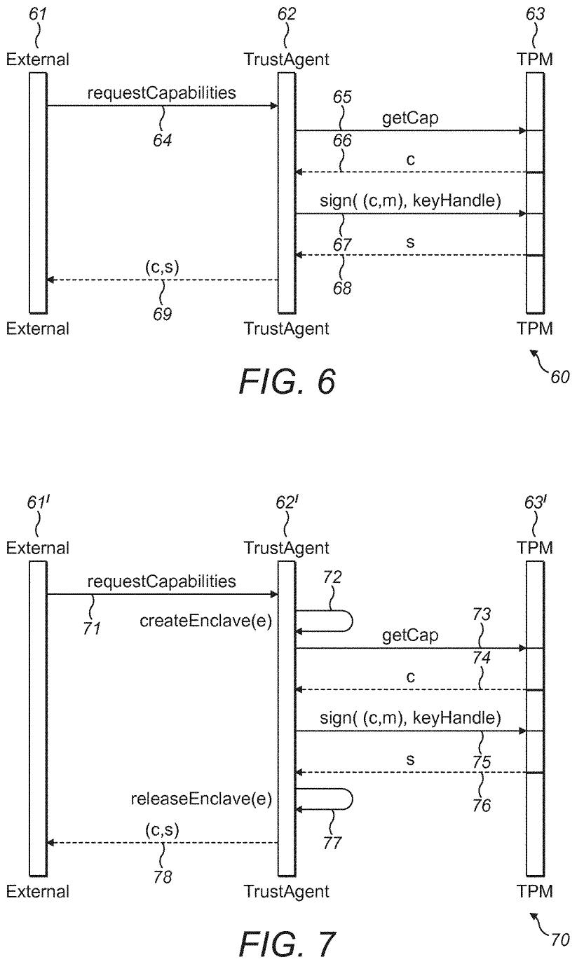

FIG. 6 shows a message sequence, indicated generally by the reference numeral 60, in accordance with an example embodiment. The message sequence 60 shows a sequence of messages between an external module 61, a trust agent 62 and a trusted platform module 63. The trust agent 62 and the trusted platform module 63 may form part of an element (such as the elements 6, 7 and 8 described above). The external module 61 may be an attestation server, such as the server 2 or 34 described above. However, the external module 61 could alternatively be some other device requesting information from the trust agent, such as a management or operating component of a cloud system. Moreover, a proxy could be used to forward requests to the trust agent on behalf of an attestation server. Another possible use case might be that a user interface component or a system status component may communicate directly with the trust agent.

The message sequence 60 begins with the external module 61 sending a requestCapabilites message 64 to the trust agent 62. The message 64 is an example of the ‘get_capabilities’ command discussed above. As discussed above, the command 64 may request information about the capabilities of the trusted platform module 63. The command 64 may include a nonce and a signing key handle that identifies the key to be used for signing the response to the message 64.

In response to the message 64, the trust agent 62 sends a getCap message 65 to the trusted platform module 63. In response to the message 65, the trusted platform module 63 returns a capabilities message 66 providing capabilities c of the device. As discussed above, the capabilities c may identify measurements (or other data) that can be provided to the external module 61.

In the event that the capability information is not signed (which is often the case), the message 66 is unsigned. On receipt of the message 66, the trust agent 62 sends an instruction to the trusted platform module 63 to sign the capabilities message using a key of the trusted platform module. Thus, a message 67 is sent to the trusted platform module 63 instructing the signing of a message including the capabilities c and metadata m, based on the key handle providing in the capabilities request 64.

In response to the message 67, the trusted platform module 63 returns a signed message 68, where the signed message s is given by:

s=(sign(c,m), keyₚᵣᵢᵥ), where keyₚᵣᵢᵥ is the private key of the trusted platform module 63 identified by the key handle.

Finally, the trust agent 62 returns a message 69 to the external module 61 including the unsigned capabilities c, and the signed capabilities s. The use of a key to generate the signed capabilities s guarantees the integrity of the information in the message 69. Thus, for example, by using a public key corresponding to keyₚᵣᵢᵥ (the private key of the TPM 63), the external module 61 can verify that the capabilities c have been signed by the trusted platform module.

FIG. 7 shows a message sequence, indicated generally by the reference numeral 70, in accordance with an example embodiment. The message sequence 70 shows a sequence of messages between an external module 61′, a trust agent 62′ and a trusted platform module 63′ (that are similar to the external module 61, trust agent 62 and trusted platform module 63 described above).

The message sequence 70 begins with the external module 61′ sending a requestCapabilites message 71 to the trust agent 62′. The message 71 is similar to the message 64 described above and may include a nonce and a signing key handle that identifies the key to be used for signing the response to the message 71.

On receipt of the message 71, the trust agent 62′ establishes an enclave (as indicated by the reference numeral 72), wherein a response to the message 71 is generated within said enclave (as described further below).

Within the enclave, the trust agent 62′ sends a getCap message 73 to the trusted platform module 63′. In response to the message 73, the trusted platform module 63′ returns a capabilities message 74 providing capabilities c of the device. As discussed above, the capabilities c may identify measurements (or other data) that can be provided to the external module 61′. The message 74 may be unsigned.

On receipt of the message 74, the trust agent 62′ sends an instruction 75 to the trusted platform module 63′ to sign the capabilities message using a key of the trusted platform module. Thus, a message 75 is sent to the trusted platform module 63′ instructing the signing of a message including the capabilities c and metadata m, based on the key handle provided in the capabilities request 71.

In response to the message 75, the trusted platform module 63′ returns a signed message 76, where the signed message s is given by:

s=(sign(c,m), keyₚᵣᵢᵥ), where keyₚᵣᵢᵥ is the private key of the trusted platform module 63′ identified by the key handle.

With the response to the message 71 generated, the enclave is released (as indicated by the reference numeral 77). Finally, the trust agent 62′ returns a message 78 to the external module 61′ including the unsigned capabilities c, and the signed capabilities s. As indicated above, the use of a key to generate the signed capabilities s guarantees the integrity of the information sent by the trust agent 62′ to the external module 61′.

The enclave described above may be implemented in many different ways, as will be apparent to those of ordinary skill in the art. Such enclaves are considered to be relatively secure and are a known method for ensuring secure remote computation. Example enclave arrangements include Software Guard Extensions (SGC), TrustZone and Trusted Execution Technology (TXT). Other options are also possible.

The algorithms 60 and 70 described above show example message sequences for providing capabilities information. Similar message sequences can be provided for other requests (such as the get_identity and get_quote requests described above).

By way of example, in response to a ‘get_quote’ request, a trust agent (such as the trust agents 62 or 62′ described above) may obtain a quote q from a trusted platform module (such as the modules 63 or 63′ described above). The trusted platform module may sign the quote using a private key of an attestation key pair (akₚᵣᵢᵥ) to return the message sign(q, akₚᵣᵢᵥ) to the trust agent. In response the trust agent may provide metadata m that can be added to generate a second signed message s₂, where: s₂=sign((q,s,m), keyₚᵣᵢᵥ).

The key for signing the message s₂ may be a key of the trusted platform module or may be obtained from elsewhere.

In the arrangement described above, the relevant keys are applied by a trusted platform module. This is not essential to all embodiments. For example, the signing process could be carried out by a hardware security module (HSM).

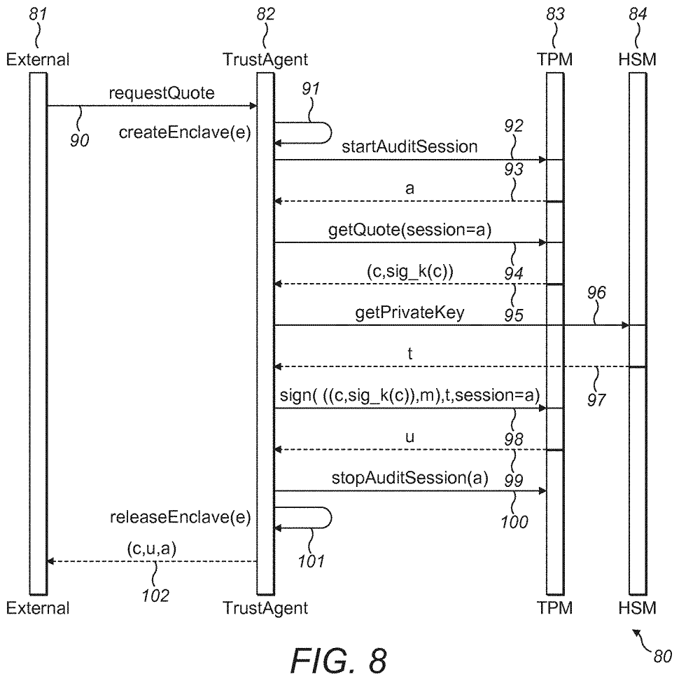

FIG. 8 shows a message sequence, indicated generally by the reference numeral 80, in accordance with an example embodiment. The message sequence 80 shows a sequence of messages between an external module 81, a trust agent 82, a trusted platform module 83 and a hardware security module (HSM) 84. The external module 81, trust agent 82 and trusted platform module 83 are similar to the external modules 61 and 61′, trust agents 62 and 62′ and trusted platform modules 63 and 63′ described above. The hardware security module is for use in cryptographically signing parts of a response to a request.

The message sequence 80 begins with the external module 81 sending a requestQuote message 90 to the trust agent 82. The message 90 is an example of the ‘get_quote’ command discussed above. The message 90 may include a nonce and a signing key handle that identifies the key to be used for signing the response to the message 90.

On receipt of the message 90, the trust agent 81 establishes an enclave (as indicated by the reference numeral 91), wherein a response to the message 90 is generated within said enclave (as described further below).

Within the enclave, the trust agent 82 sends a message 92 to the trusted platform to set up a TPM audit session. The provision of a TPM audit session may enable the recovery of a session if a session is interrupted. In response to the message 92, the trusted platform module returns a session key a. Information relating to the session can be stored encrypted under the session key a.

Still within the enclave, the trust agent 82 sends a getquote message 94 to the trusted platform module 83, identifying the session a. In response to the message 94, the trusted platform module 83 returns a signed quote, in message 95.

A second level of encryption is provided by requesting a private key from the hardware security module (HSM) 84 in a message 96. The HSM returns a key, t, in a message 97. On receipt of the message 97, the trust agent 82 sends an instruction 98 to the trusted platform module 83 to sign the quote using the key obtained from the HSM 84. Thus, a message 98 is sent to the trusted platform module 83 instructing the signing of a message including the signed quote c and metadata m, based on the key t.

In response to the message 98, the trusted platform module 83 returns a signed message 99, where the signed message u is given by:

u=(((c, sig_k(c)), m), t, session=a).

On receipt of the message 99, the audit session is stopped (message 100) and the enclave is released (as indicated by the reference numeral 101). Finally, the trust agent 82 returns a message to the external module 81 including the unsigned signed quote c, the signed message u and details of the session a.

Of course, the message sequence 80 could be modified, for example by omitting the use of an enclave and/or the use of the HSM 84.

The algorithm 81 described above show an example message sequence for providing quote information. Similar message sequences can be provided for other requests (such as the get_identity and get_capabilities requests described above).

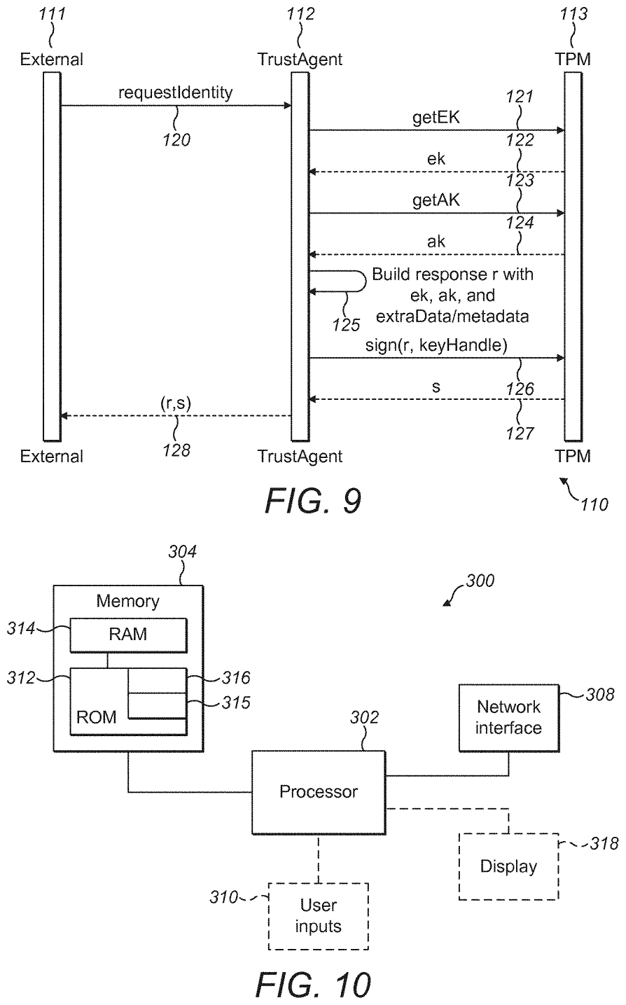

FIG. 9 shows a message sequence, indicated generally by the reference numeral 110, in accordance with an example embodiment. The message sequence 90 shows a sequence of messages between an external module 111, a trust agent 112 and a trusted platform module 113 (that are similar to the external modules 61, 61′ and 81, the trust agents 62, 62′ and 82, and the trusted platform modules 63, 63′ and 83 described above).

The message sequence 90 begins with the external module 111 sending a requestIdentity message 120 to the trust agent 112. The message 120 is an example of the ‘get_identity’ command discussed above. As discussed above, the command 120 may request information about the identity of the trusted platform module 113. The command 120 may include a nonce and a signing key handle that identifies the key to be used for signing the response to the message 120.

In response to the message 120, the trust agent 112 sends a getEK message 121 to the trusted platform module 113. In response to the message 121, the trusted platform module 113 returns the public key of the endorsement key (EK) pair of the trusted platform module 113 in a message 122. The trust agent 112 then sends a getAK message 123 to the trusted platform module 113. In response to the message 123, the trusted platform module 113 returns the public key of the attestation key (AK) pair of the trusted platform module 113 in a message 124. Of course, the messages 121 and 123 may be sent in a different order or combined into a single request.

On the basis of the information provided in the messages 122 and 124 (which messages may be provided in a different order or combined into a single message), the trust agent 112 constructs an initial response r (as indicated by the reference numeral 125) to the request identity message 120. That response includes the endorsement key (EK) and attestation key (AK) and may additionally include other information, such as metadata or extra data (such as an IP address, MAC address, system information OpenStack ID etc.).

In the event that the key information provided in the messages 122 and 124 is not signed (which is often the case), the response r is unsigned. On generation of the response r, the trust agent 112 sends an instruction to the trusted platform module 113 to sign the response message using a key of the trusted platform module. Thus, a message 126 is sent to the trusted platform module 113 instructing the signing of a message including the response r, based on the key handle providing in the identity request 120.

In response to the message 126, the trusted platform module 113 returns a signed message 127, where the signed message s is given by:

s=(sign r, keyₚᵣᵢᵥ), where keyₚᵣᵢᵥ is the private key of the trusted platform module 113 identified by the key handle.

Finally, the trust agent 112 returns a message 128 to the external module 11 including the unsigned response r, and the signed response s. The use of a key to generate the signed response s guarantees the integrity of the information in the message 128. Thus, for example, by using a public key corresponding to keyₚᵣᵢᵥ (the private key of the TPM 113), the external module 11 can verify that the response r has been signed by the trusted platform module.

For completeness, FIG. 10 is a schematic diagram of components of one or more of the example embodiments described previously, which hereafter are referred to generically as processing systems 300. A processing system 300 may have a processor 302, a memory 304 closely coupled to the processor and comprised of a RAM 314 and ROM 312, and, optionally, user input 310 and a display 318. The processing system 300 may comprise one or more network/apparatus interfaces 308 for connection to a network/apparatus, e.g. a modem which may be wired or wireless. Interface 308 may also operate as a connection to other apparatus such as device/apparatus which is not network side apparatus. Thus, direct connection between devices/apparatus without network participation is possible.

The processor 302 is connected to each of the other components in order to control operation thereof.

The memory 304 may comprise a non-volatile memory, such as a hard disk drive (HDD) or a solid-state drive (SSD). The ROM 312 of the memory 314 stores, amongst other things, an operating system 315 and may store software applications 316. The RAM 314 of the memory 304 is used by the processor 302 for the temporary storage of data. The operating system 315 may contain code which, when executed by the processor implements aspects of the algorithms 20 and 40 or the message sequences 30, 60, 70, 80 and 110 described above. Note that in the case of small device/apparatus the memory can be most suitable for small size usage i.e. not always hard disk drive (HDD) or solid-state drive (SSD) is used.

The processor 302 may take any suitable form. For instance, it may be a microcontroller, a plurality of microcontrollers, a processor, or a plurality of processors.

The processing system 300 may be a standalone computer, a server, a console, or a network thereof. The processing system 300 and needed structural parts may be all inside device/apparatus such as IoT device/apparatus i.e. embedded to very small size In some example embodiments, the processing system 300 may also be associated with external software applications. These may be applications stored on a remote server device/apparatus and may run partly or exclusively on the remote server device/apparatus. These applications may be termed cloud-hosted applications. The processing system 300 may be in communication with the remote server device/apparatus in order to utilize the software application stored there.

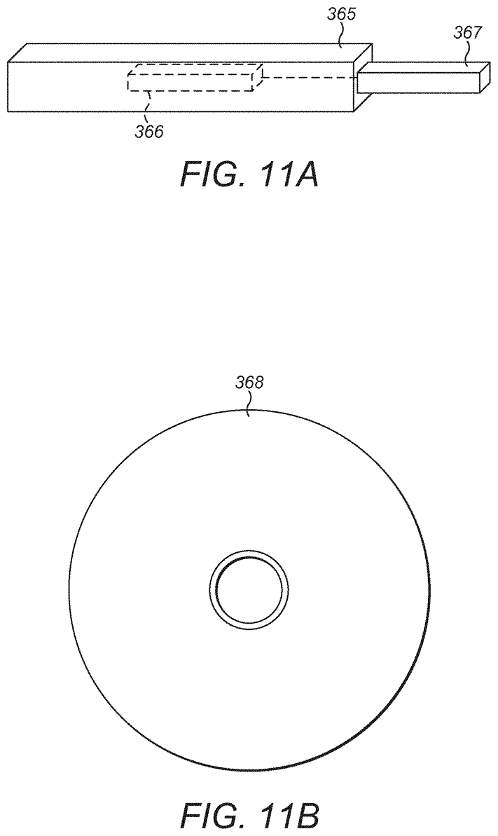

FIGS. 11A and 11B show tangible media, respectively a removable memory unit 365 and a compact disc (CD) 368, storing computer-readable code which when run by a computer may perform methods according to example embodiments described above. The removable memory unit 365 may be a memory stick, e.g. a USB memory stick, having internal memory 366 storing the computer-readable code. The memory 366 may be accessed by a computer system via a connector 367. The CD 368 may be a CD-ROM or a DVD or similar. Other forms of tangible storage media may be used. Tangible media can be any device/apparatus capable of storing data/information which data/information can be exchanged between devices/apparatus/network.

Embodiments of the present invention may be implemented in software, hardware, application logic or a combination of software, hardware and application logic. The software, application logic and/or hardware may reside on memory, or any computer media. In an example embodiment, the application logic, software or an instruction set is maintained on any one of various conventional computer-readable media. In the context of this document, a “memory” or “computer-readable medium” may be any non-transitory media or means that can contain, store, communicate, propagate or transport the instructions for use by or in connection with an instruction execution system, apparatus, or device, such as a computer.

Reference to, where relevant, “computer-readable storage medium”, “computer program product”, “tangibly embodied computer program” etc., or a “processor” or “processing circuitry” etc. should be understood to encompass not only computers having differing architectures such as single/multi-processor architectures and sequencers/parallel architectures, but also specialised circuits such as field programmable gate arrays FPGA, application specify circuits ASIC, signal processing devices/apparatus and other devices/apparatus. References to computer program, instructions, code etc. should be understood to express software for a programmable processor firmware such as the programmable content of a hardware device/apparatus as instructions for a processor or configured or configuration settings for a fixed function device/apparatus, gate array, programmable logic device/apparatus, etc.

As used in this application, the term “circuitry” refers to all of the following: (a) hardware-only circuit implementations (such as implementations in only analogue and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a server, to perform various functions) and (c) to circuits, such as a microprocessor(s) or a portion of a microprocessor(s), that require software or firmware for operation, even if the software or firmware is not physically present.

If desired, the different functions discussed herein may be performed in a different order and/or concurrently with each other. Furthermore, if desired, one or more of the above-described functions may be optional or may be combined. Similarly, it will also be appreciated that the flow charts and message sequences of FIGS. 3 to 9 are examples only and that various operations depicted therein may be omitted, reordered and/or combined.

It will be appreciated that the above described example embodiments are purely illustrative and are not limiting on the scope of the invention. Other variations and modifications will be apparent to persons skilled in the art upon reading the present specification.

Moreover, the disclosure of the present application should be understood to include any novel features or any novel combination of features either explicitly or implicitly disclosed herein or any generalization thereof and during the prosecution of the present application or of any application derived therefrom, new claims may be formulated to cover any such features and/or combination of such features.

1. An apparatus comprising:
at least one processor; and
at least one memory including computer program code, the at least one memory and the computer program configured, with the at least one processor, to cause the apparatus to perform,
receiving a request at an element of a distributed or cloud computing system, wherein said request includes a command; a nonce; and details of a cryptographic key for use in responding to the request;
m generating a response to said request at said element of said computing system, wherein said response includes one or more of an identity of said element; a cryptographic hash of data representing configurations of said element; and capabilities relating to said element of the computing system; and
m providing said response in response to said request, wherein said response includes said nonce and is signed using said cryptographic key.

2. An apparatus as claimed in claim 1, wherein the receiving receives the request from an attestation server, and the providing provides the response to the attestation server.

3. An apparatus as claimed in claim 2, further comprising a trust agent at said element of said computing system for providing an interface between said element of the computing system and said attestation server.

4. An apparatus as claimed in claim 1, further comprising a trusted platform module associated with said element of said computing system.

5. An apparatus as claimed in claim 4, wherein the identity of said element includes public keys of said trusted platform module.

6. An apparatus as claimed in claim 4, wherein the identity of said element includes public keys of one or more of an endorsement key pair and an attestation key pair.

7. An apparatus as claimed in claim 4, wherein said cryptographic hash of data representing configurations of said element is generated by said trusted platform module.

8. An apparatus as claimed in claim 1, wherein said cryptographic hash of data representing configurations of said element is a cryptographic hash of data representing one or more of hardware, firmware and software configurations of said element.

9. An apparatus as claimed in claim 1, wherein at least some of said data representing configurations of said element are stored in one or more platform configuration registers.

10. An apparatus as claimed in claim 1, wherein said capabilities comprise identity measurements.

11. An apparatus as claimed in claim 1, wherein the at least one memory and the computer program code are configured to, with the at least one processor, cause the apparatus at least to perform
generating a first response that includes said nonce and is signed using said cryptographic key; and
generating a second response that includes said first response and metadata and is signed using a second cryptographic key,
wherein said providing provides the response based on said second response.

12. An apparatus as claimed in claim 1,
wherein the at least one memory and the computer program code are configured to, with the at least one processor, cause the apparatus at least to perform establishing an enclave, wherein said response is generated within said enclave.

13. An apparatus as claimed in claim 1, wherein the at least one memory and the computer program code are configured to, with the at least one processor, cause the apparatus at least to cryptographically sign parts of said response to said request.

14. An apparatus as claimed in claim 1, wherein said element is one of a plurality of elements of the computing system.

15. (canceled)

16. (canceled)

17. A method comprising:
receiving a request, from a first module, at an element of a distributed or cloud computing system, wherein said request includes: a command; a nonce; and details of a cryptographic key for use in responding to the request;
generating a response to said request at a trust agent of said element of said computing system, wherein said response includes one or more an identity of said element; a cryptographic hash of data representing configurations of said element; and capabilities relating to said element of the computing system; and
providing said response in response to said request, wherein said response includes said nonce and is signed using said cryptographic key.

18. A method as claimed in claim 17, further comprising:
generating a first response that includes said nonce and is signed using said cryptographic key; and
generating a second response that includes said first response and metadata and is signed using a second cryptographic key,
wherein the providing provides the response in response to said request based on said second response.

19. A method as claimed in claim 17, further comprising establishing an enclave, wherein said response is generated within said enclave.

20. A non-transitory computer readable medium comprising program instructions stored thereon that when executed by a processor, cause the apparatus including the processor to perform,
receiving a request at an element of a distributed or cloud computing system, wherein said request includes a command; a nonce; and details of a cryptographic key for use in responding to the request;
generating a response to said request at a trust agent of said element of said computing system, wherein said response includes one or more of an identity of said element; a cryptographic hash of data representing configurations of said element; and capabilities relating to said element of the computing system; and
providing said response in response to said request, wherein said response includes said nonce and is signed using said cryptographic key.
